(19) United States
(12) Patent Application Publication
(10) Pub. No.: US 2008/0097877 A1
(43) Pub. Date: Apr. 24, 2008

(54) Method and System for Investing in Commodity Futures Contracts

(75) Inventor: George D. Rahal, Glenelg, MD (US)

Correspondence Address: MILES & STOCKBRIDGE PC, 1751 PINNACLE DRIVE, SUITE 500, MCLEAN, VA, 22102-3833, US

(73) Assignee: Longview Funds Management, LCC, Columbia, MD (US)

(21) Appl. No.: 11/718,210

(22) PCT Filed: Nov. 2, 2005
(86) PCT No.: PCT/US05/39618

§ 371 Date: Apr. 27, 2007

Related U.S. Application Data
(60) Provisional application No. 60/623,856, filed on Nov. 2, 2004.

(51) Int. Cl. G06Q 40/00; G06Q 10/00

(52) U.S. Cl. 705/30

(57) ABSTRACT

In accordance with an embodiment of the present invention, a method for providing a commodities index trading investment system may include selecting (110) a plurality of commodity groupings for an index; selecting (120) one or more commodities in each of the plurality of commodity groupings; and buying (130) highly collateralized longer-dated futures contracts for each of the one or more commodities. The method may also include selling (140) each of the highly collateralized longer-dated futures contracts on a last day of trading in a month that is at least two-months earlier than the expiration date of the nearest longer-dated futures contract; and buying (150) a next-year's highly collateralized longer-dated futures contract of another commodity for each highly collateralized longer-dated futures contract sold. The method may still further include paying (160) fees and commissions associated with the management of the index as well as those associated with the buying and selling of the futures contracts in the index; updating (170) account balances to reflect the net effect of the buying and selling of the futures contracts and the fee and commission charges; and paying-out (180) proceeds to investors, as required.

### FIELD OF THE INVENTION

The present invention relates to a method and system for commodities investing in traditional, non-financial commodity futures contracts, specifically, commodity futures contracts that are not correlated with stocks, and/or stock funds and/or bonds.

### BACKGROUND OF THE INVENTION

Modern portfolio theory says that “optimal portfolios” must contain “dissimilar” assets to achieve positive returns and maintain low correlations between asset investments. In response, the fund industry created fund “categories” (e.g., style: growth vs. value; size: large vs. small Cap; and geography: domestic vs. foreign) to allegedly meet this essential portfolio need. Unfortunately, these “categories” do not have the requisite low correlations, i.e., correlations near zero or negative correlations (0 to −1.0 or 0% to −100%). Highly correlated investments have correlation coefficients close to 1.0 or 100%. In fact, data from 1986 to 2004 for each of the “categories” shows almost exactly the opposite of low correlation. Specifically, over this time period, growth vs. value stocks had an 89% correlation, foreign vs. domestic stocks had a 90% correlation, and large vs. small cap stocks had an 80% correlation.

Accordingly, it is desirable to provide a system and method that may provide a negatively correlated index for investing in commodity futures contracts, such as, non-financial, commodity futures contracts.

### BRIEF DESCRIPTION OF THE DRAWINGS

The invention will be best understood by reading the ensuing specification in conjunction with the drawing figures, in which like elements are designated by like reference numerals, and wherein:

FIG. 1 illustrates a flow diagram for a system and method of providing commodity futures contract trading, in accordance with an embodiment of the present invention.

FIG. 2 illustrates a flow diagram for a system and method of providing commodity futures contract trading, in accordance with another embodiment of the present invention.

FIG. 3 illustrates a flow diagram for a system and method of providing commodity futures contract trading, in accordance with yet another embodiment of the present invention.

FIG. 4 illustrates a flow diagram for a system and method of providing commodity futures contract trading, in accordance with still another embodiment of the present invention.

FIG. 5 illustrates a flow diagram for a system and method of providing commodity futures contract trading, in accordance with yet another embodiment of the present invention.

FIG. 6 illustrates a flow diagram for a system and method of providing commodity futures contract trading, in accordance with yet another embodiment of the present invention.

FIG. 7 illustrates a flow diagram for a system and method of providing commodity futures contract trading, in accordance with yet another embodiment of the present invention.

FIG. 8 illustrates a flow diagram for a system and method of providing commodity futures contract trading, in accordance with yet another embodiment of the present invention.

FIG. 9 illustrates a flow diagram for a system and method of providing commodity futures contract trading, in accordance with yet another embodiment of the present invention.

### DETAILED DESCRIPTION OF THE PREFERRED EMBODIMENTS

In accordance with an embodiment of the present invention, a Commodity Index Program (the “Program”) may be designed to offer participants long-term exposure to commodity price movements and provide diversification and potential return benefits that may not be available from traditional portfolios in equities and fixed income investments.

While many stock and bond investments historically rise and fall together (i.e., are highly correlated), commodity price movements may show low correlation to stock and bond prices (i.e., are not correlated). In accordance with an embodiment of the present invention, in general, the Commodity Index program may offer suitable investors the diversification and potential return benefits available from commodities markets within a context of an unmanaged commodities index versus actively managed commodities alternatives.

To accomplish this, the Commodity Index program may select and invest in commodities in four major commodity groupings, for example: Energy, Metals, Grains and Softs. In pursing an overall goal of long-term commodities exposure with diversification benefits, the Commodity Index program may seek to be as tax-efficient as possible by utilizing select highly (or fully) collateralized longer-dated futures contracts providing a minimum of “rollovers” per year, for example, one “rollover” per year.

In accordance with an embodiment of the present invention, selecting longer-dated contracts may reduce the number of rollovers and their associated rollover risks and may increase the tax efficiency of commodity accounts. Highly (or fully) collateralized accounts may reduce participant exposure to forced liquidations from margin calls and further the program objective of holding positions for the long-term.

The Commodity Index

In accordance with an embodiment of the present invention, the Commodity Index Program may track the return of a proprietary Commodity Index, which may be a rules-based index composed of 12 of the most liquid non-financial “traditional” commodity futures contracts across four basic commodity groups, for example: Energy, Grains, Metals and Softs. The 12 contracts may be chosen in order to make the index diversified, yet easier to follow than if it contained more components. However, in accordance with some other embodiments of the present invention, more than 12 contracts may be included in the index.

For example, in accordance with an embodiment of the present invention, the 12-contract index composition may include:

Energy:

December Crude Oil

December Heating Oil

December Natural Gas

Grains:

December Corn

December Wheat

November Soybeans

Metals:

December Gold

December Silver

December Copper

Softs:

December Coffee

December Cocoa

November Frozen Concentrated Orange Juice (FCOJ)

Note: Due to availability, the November contract, not December, may be traded (i.e., purchased/bought) for both Soybeans and FCOJ.

While changes in the index composition are not required, changes may be made at any time.

Rollovers

Given that futures contracts trade on the basis of delivery months, any long-term commodity futures index must include a method for “continuation” or “rolling over” of expiring positions into continuing positions.

In accordance with an embodiment of the present invention, in general, the index may contain contracts having December delivery months for each of 12 commodities. It is also possible to have November contracts, if December contracts are not available for specific commodities. December is mid-season for many commodities and may be considered more representative of long-term value than other, more seasonally based, months. However, this example should not be construed so as to limit the present invention, since other embodiments are contemplated in which other months, for example, January through November, may be the end month for the longer-dated contracts. In general, this may vary with which commodity groups are selected. Also, as the size of the fund becomes very large, it may be necessary to “ladder” the fund, i.e., stagger the rollovers of the contracts so that not all of the contracts rollover at the same time.

Further, the index assumes that all positions “rollover” on the last trading day of the month that is, approximately, three months before the end date of the “near” month futures contracts. For example, for December contracts, the previous September is the trading month (i.e., on the last trading day of September the index “sells” the “near” December contract and “buys” the “next” December contract for each of the commodities in the index). This rule preserves the longer-term nature of the index and attempts to avoid excessive volatility of near-term holdings. The “near” December contract is the contract that will be expiring in the upcoming December, specifically; the “near” December contract in September 2004 is the December 2004 contract. Similarly, the “next” December contract is the contract for December of the following year. Specifically, the “next” December contract in September 2004 is a December 2005 contract. In the cases where the “near” contract is November, embodiments of the present invention may rollover in August (i.e., three months before the expiration of the November contract). Alternatively, the November contracts may, optionally, be held an additional month to be able to be rolled over with the December contracts in September. This may permit the “next” contracts in the index to be purchased as all December contracts.

Additional Program Information

In accordance with an embodiment of the present invention, the program may be composed of purchasing and rolling over the same contracts that make up the index. While the program may attempt to duplicate the index, there is no guarantee that the program will match any preset return. By definition, any index is hypothetical; it incurs no real world expenses or rollover risks. There is no guarantee that any program participant can or will obtain the index returns.

In addition to purchasing the individual contracts above, available commodity index futures contracts such as the CRB futures contracts or the GSCI futures contract may be traded as well.

In general, while the program is designed to provide a diversified exposure to commodity market price movements, the exact composition of each account may vary due to funding, weighting and timing differences between accounts.

Larger accounts may own all the contracts above. Smaller accounts may own a diversified subset (i.e., a “basic” subset, which may only include a single commodity from each of the four selected groupings, for example: Crude Oil, Soybeans, Gold and Coffee). Positions in the index futures contracts may be held in both large and small accounts.

Given the long-term, indexed exposure objective of the program, accounts are recommended (but not required) to be as fully collateralized as possible. If all 12 of the commodity contracts were to be fully collateralized at current market prices (at the August 2004 month-end close) the total funds required for one account would approximate $400,000 per 12-contract position or “unit”. Similarly, if the “Basic” subset of 4 commodity contracts were to be fully collateralized, the total funds required for one account would approximate $130,000 at current market prices. For comparison purposes, one contract of the CRB Futures index, fully collateralized, is valued at approximately $150,000.

In accordance with an embodiment of the present invention, if an account were to be highly leveraged and post minimum margins, a complete suite of 12 long positions would require, using reasonable estimated retail minimum margins, approximately $70,000 representing significant leverage of approximately 6 to 1, ($70,000 margin to control over $400,000 of commodity value). Similarly, the “Basic” subset of four positions, at estimated retail margins, may require only a $25,000 deposit to control $130,000 of value or 5 to 1 leverage. The estimated required deposit for one CRB is $5,000, representing 30 to 1 leverage.

In general, it is recommend that program participants do not carry significant leverage, since leverage is contrary to the objective of long-term exposure to commodity price changes. Thus, highly leveraged positions may subject participants to increased risk of margin calls and the risks of forced liquidation.

If the program were to grow to astronomical proportions, the program would likely face added management limits, liquidity limits, and position size limits. Each $1 Billion invested in the program would require 2500 “units” or 2500 contracts for each of the 12 commodities in the program. If the program were to approach such a size, it is likely that more than the December trading month and more than 12 commodities would be traded.

FEE

A complete description of each management fee charged the client by the Advisor for services rendered is presented below:

Monthly management fee: 0.1667%

At the end of each month, the client will be charged a fee of 0.1667% of account equity. The first monthly management fee will be prorated as follows: “days in program/days in month”×0.1667%. The base amount to calculate this fee will be the actual account equity balance shown on the client's month-end account statement.

Withdrawal fee: 1%

Upon any withdrawal, partial or full, from the program, the client may be charged a fee of 1% of the total amount withdrawn, depending on the time in the fund. The base amount to calculate this fee will be the actual dollar amount requested to be withdrawn from the client's account.

Account Equity Calculation:

As base amounts, in this case, the “account equity” are used in determining the monthly management fee, this Document must explain how the base amounts will be calculated pursuant to CFTC Regulation 4.34(i)(2).

Account equity equals the sum of deposits, open trade equity, trading profits and any interest earned on excess balances minus any withdrawals, trading losses, commissions and any fees/expenses incurred by the customer's commodity account. An individual's account equity is computed by the FCM selected by the customer.

In accordance with an embodiment of the present invention, a set of principles that define the index may include being easy to understand, in that it may be: an investible, self-tracking, direct invested, easy “continuation” commodity index; be accessible to the average investor, yet complete and theoretically valid; have well defined components that avoid esoteric theoretical frameworks; and accepts market decisions on most theoretical issues (e.g., weights, valuations). The principles may also represent the asset class by including 12 of the most liquid commodities (3 each from 4 major groupings); accept market decisions on most theoretical issues (e.g., weights, valuations); providing competitive long-term returns; and having a strong non-correlation to stock portfolios. The principles may further represent long-term value by buying and holding the December contract (or nearest to December contract); rolling once per year; seeking to avoid rolling in a nearby month (i.e., a month less than three months before the December contract); providing competitive long-term returns; and providing strong non-correlation to stock portfolios

In accordance with an embodiment of the present invention, the principles may still further include avoiding unnecessary volatility by avoiding rolling over contracts in a nearby month and/or in a “high season”. The principles may also include minimizing fees & costs by buying and holding long-term contracts to avoid transaction costs associated with frequent rollovers; avoiding nearby rolls to reduce rollover costs; rolling over once per year to avoid transaction and rollover costs; using a low fee structure compared to other commodity investments; and the direct-nature of the investments may reduce “hidden” costs found within “derivative” investments. The principles may further include maximizing the tax efficiency of the index by buying and holding the contracts to minimize capital gains events; and seeking specialized tax treatment due to non-leveraged position. The principles may still further include being a proprietary index to avoid licensing fees and to remedy complexity, investability, tracking, and other problems found in other indexes.

In accordance with some embodiments of the present invention, the method and system may be implemented as a software program that may be stored on a machine-readable medium and include executable instructions for performing the inventive method. Likewise, the system may include a machine, for example, a computer, to read the software program from the machine-readable medium and execute the instructions that are contained therein. The computer may include any general or special purpose computer with a processing unit that can read decode and execute the instructions. The computer may also include a keyboard, mouse or other input/output device; a display; and/or output device(s), for example, printer, mass memory devices, communications equipment, and/or speakers.

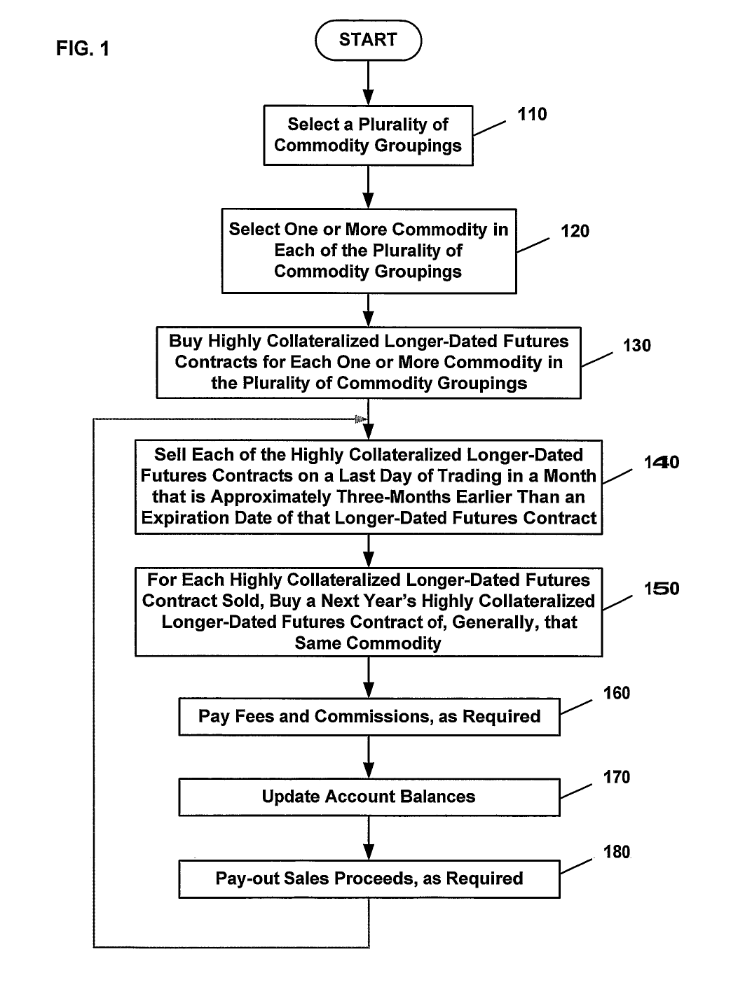

FIG. 1 illustrates a flow diagram for a system and method of providing commodity futures contract trading, in accordance with an embodiment of the present invention. In FIG. 1, the method may include selecting (110) a plurality of commodity groupings from which to select specific commodities for an index. For example, the plurality of commodity groupings may include four, non-financial, “traditional” basic commodity groups, such as, Energy, Grains, Metals and Softs. The energy group may include oil, gas, etc. commodities; the grain group may include corn, wheat, soybeans, etc. commodities; the metals group may include gold, silver, copper, etc. commodities; and the softs group may include coffee, cocoa, frozen concentrated orange juice, etc. commodities. The previous commodity examples are merely illustrative of an embodiment of the present invention, and in no way should be construed to limit the present invention to that specific embodiment.

In FIG. 1, in accordance with the embodiment of the present invention, the method may include selecting (120) one or more commodities in each of the plurality of commodity groupings. For example, three commodities may be selected (120) in each of the plurality of commodity groupings. The method may include buying (130) highly collateralized longer-dated futures contracts for each of the one or more commodities, for example, three commodities, in the plurality of commodity groupings. In general, this purchase will occur as far in advance of the expiration of the longer-dated futures contracts as possible. For example, the December 2005 futures contracts may be bought (130) in September 2004. The method may also include selling (140) each of the highly collateralized longer-dated futures contracts on a last day of trading in a month that is three-months earlier than the expiration date of the nearest longer-dated futures contract. For example, a December 2004 futures contract would be sold (140) on the last trading day in September 2004.

In FIG. 1, in accordance with the embodiment of the present invention, the method may include buying (150) a next-year's highly collateralized longer-dated futures contract of a same or different commodity for each highly collateralized longer-dated futures contract sold (140). For example, if a December 2004 Coffee contract was sold (140), a December 2005 Coffee contract may be bought (150). Alternatively, if the December 2005 Coffee contract is not available, a November 2005 Coffee contract may be bought (150). Conversely, if no sufficiently longer-dated 2005 Coffee contracts are available, a longer-dated futures contract for another commodity in the same commodity grouping as Coffee may be bought (150). The method may further include paying (160) fees and commissions associated with the management of the index as well as those associated with the buying and selling of the futures contracts in the index. The method may still further include updating (170) account balances to reflect the net effect of the buying (130, 150) and selling (140) of the futures contracts and the fee and commission charges. The method may pay out (180) proceeds realized from selling (140), if a decision was taken (not shown) not to buy (150) next year's highly collateralized longer-dated futures contracts to replace the one(s) just sold (140) and cash-out some or all of the balance in the investment account.

Although, in accordance with the embodiment of the present invention, FIG. 1 illustrates the elements of the method in specific relation to each other, this is not to imply a specific order, as the elements of the method may be performed in a variety of orders that may and/or may not be independent of each other. In addition, some elements may be performed simultaneously with other elements. Likewise, in an alternative embodiment, instead of having multiple commodity groupings, only one commodity grouping may be used, for example, energy, and multiple specific commodities, for example, crude oil, heating oil and natural gas, may be purchased. The same holds true for each of the subsequently described methods.

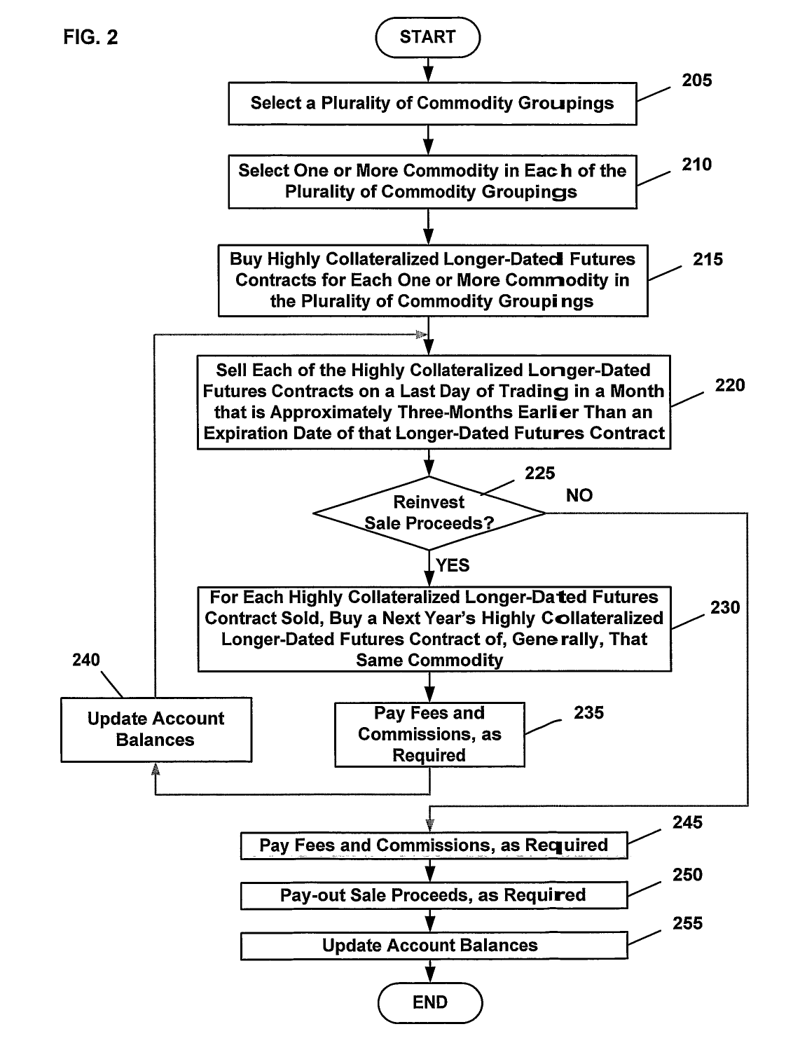

FIG. 2 illustrates a flow diagram for a system and method of providing commodity futures contract trading, in accordance with another embodiment of the present invention. In FIG. 2, the method may include selecting (205) a plurality of commodity groupings (205), selecting one or more commodities in each of the plurality of commodity groupings, and buying (215) highly collateralized longer-dated futures contracts for each one or more commodity in the plurality of commodity groupings. The method may also include selling (220) each highly collateralized longer-dated futures contracts on a last day of trading in a month that is approximately three-months earlier than an expiration date of that longer-dated futures contract. The method may also include determining (225) whether to reinvest any proceeds from selling (220) the longer-dated futures contracts. If it is determined (225) that the proceeds are to be reinvested, for each highly collateralized longer-dated futures contract sold, buying (230) a next year's highly collateralized longer-dated futures contract of, generally, that same commodity, paying (235) fees and commissions, as required, and updating (240) account balances by, for example, adding proceeds to and subtracting fees and commissions from the account balances. The method may then loop back to and continue from selling (220) each of the next year's highly collateralized longer-dated futures contract on a last day of trading in a month that is three-months earlier than an expiration date of that longer-dated futures contract. If it is determined (225) that the proceeds are not to be reinvested, for each highly collateralized longer-dated futures contract sold, the method includes, paying (235) fees and commissions, as required, paying-out proceeds from the sale of each highly collateralized longer-dated futures contract sold, and updating (240) account balances. Embodiments are also contemplated in which the fund may be laddered so that not all of the contracts rollover in the same month.

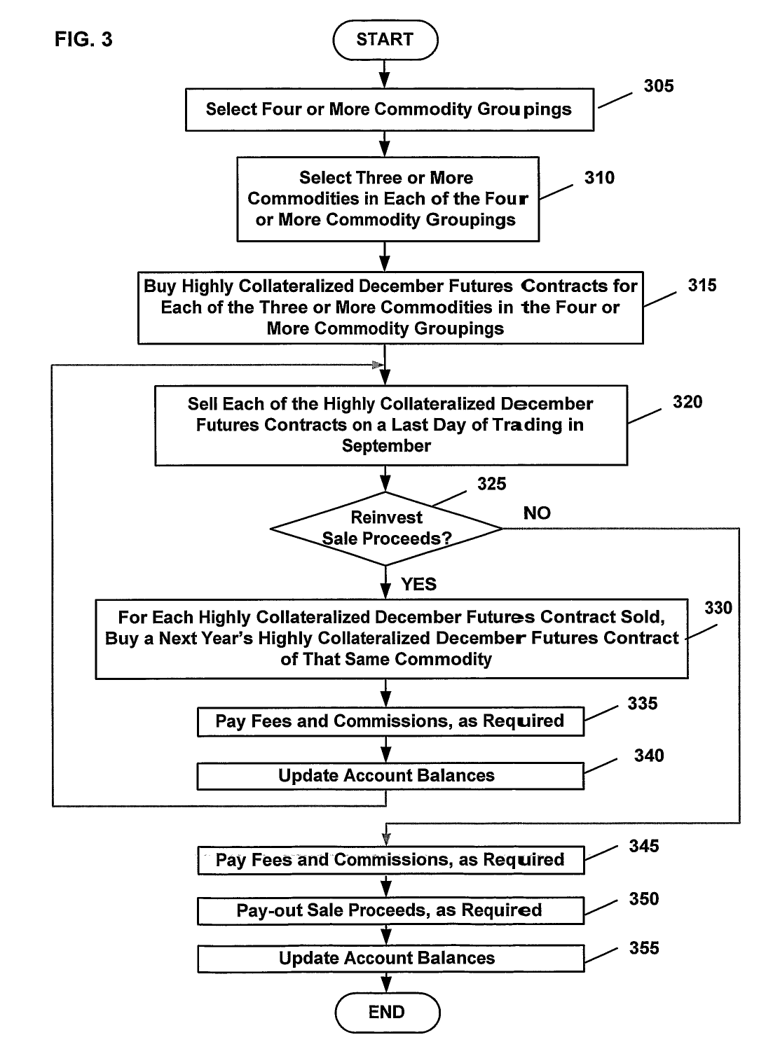

FIG. 3 illustrates a flow diagram for a system and method of providing commodity futures contract trading, in accordance with yet another embodiment of the present invention. In FIG. 3, the method may include selecting (305) four or more commodity groupings, selecting (310) three or more commodities in each of the four or more commodity groupings, and buying (315) highly collateralized December futures contracts for each of the three or more commodities in the four or more commodity groupings. For example, in September 2005, the method would buy December 2006 futures contracts. The method may also include selling (320) each highly collateralized December futures contract on a last day of trading in a September that is three-months earlier than an expiration date of that December futures contract. For example, in September 2006, the method would sell December 2006 futures contracts. The method may also include determining (325) whether to reinvest any proceeds from selling (320) the December futures contracts. If it is determined (325) that the proceeds are to be reinvested, for each highly collateralized December futures contract sold, buying (330) a new next year's highly collateralized December futures contract of, generally, that same commodity. For example, in September 2006, the method would buy December 2007 futures contracts. The method may also include paying (335) fees and commissions, as required, and updating (340) account balances by, for example, adding proceeds to and subtracting fees and commissions from the account balances. The method may then loop back to and continue from selling (320) each of the next year's highly collateralized December futures contract on a last day of trading in a September that is three-months earlier than an expiration date of that December futures contract. Continuing the examples from above, the September before the new next year's highly collateralized December futures contract, may be September 2007. If it is determined (325) that the proceeds are not to be reinvested, for each highly collateralized December futures contract sold, the method may include paying (345) fees and commissions, as required, paying-out (350) proceeds from the sale of each highly collateralized December futures contract sold, and updating (355) account balances. Embodiments are also contemplated in which the fund may be laddered so that not all of the contracts rollover in September.

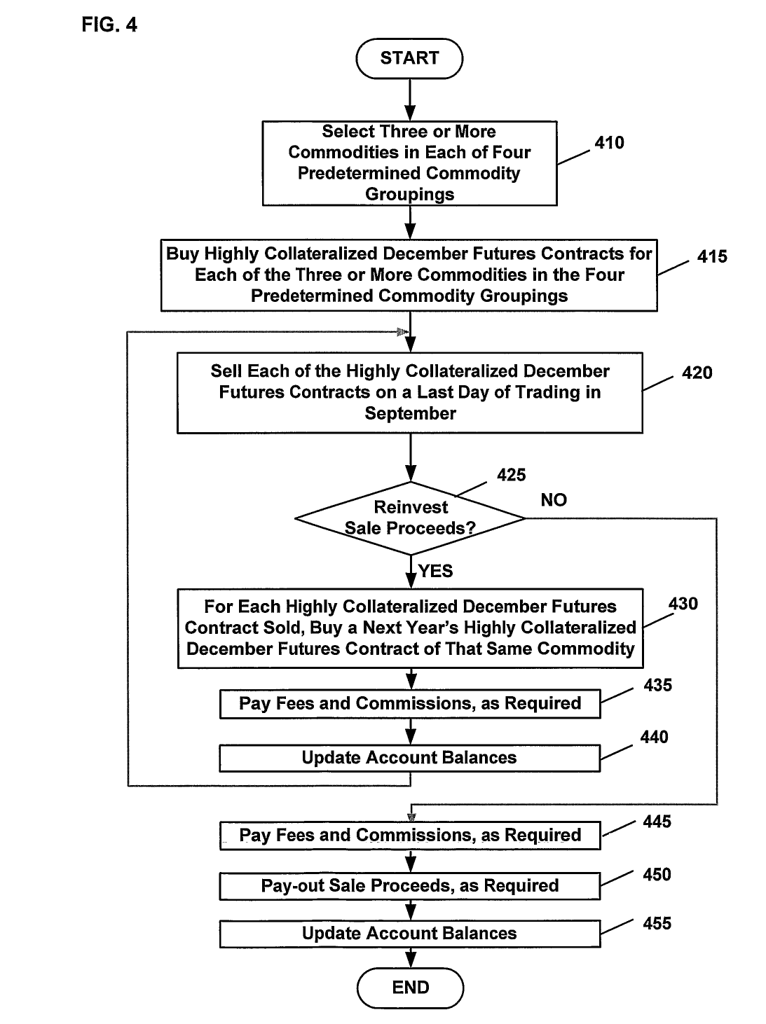

FIG. 4 illustrates a flow diagram for a system and method of providing commodity futures contract trading, in accordance with still another embodiment of the present invention. In FIG. 4, the method may include selecting (410) three or more commodities in each of four predetermined commodity groupings, and buying (415) highly collateralized December futures contracts for each of the three or more commodities in the four predetermined commodity groupings. For example, in September 2005, the method would buy December 2006 futures contracts. The method may also include selling (420) each of the highly collateralized December futures contract on a last day of trading in a September that is three-months earlier than an expiration date of that December futures contract. For example, in September 2006, the method would sell December 2006 futures contracts. The method may also include determining (425) whether to reinvest any proceeds from selling (420) the December futures contracts. If it is determined (425) that the proceeds are to be reinvested, for each highly collateralized December futures contract sold, buying (430) a next year's highly collateralized December futures contract of, generally, that same commodity. For example, in September 2006, the method would buy December 2007 futures contracts. The method may also include paying (435) fees and commissions, as required, and updating (440) account balances by, for example, adding proceeds to and subtracting fees and commissions from the account balances. The method may then loop back to and continue from selling (420) each of the next year's highly collateralized December futures contract on a last day of trading in a September that is three-months earlier than an expiration date of that December futures contract. If it is determined (425) that the proceeds are not to be reinvested, for each highly collateralized December futures contract sold, the method may include paying (445) fees and commissions, as required, paying-out (450) proceeds from the sale of each highly collateralized December futures contract sold, and updating (455) account balances. Embodiments are also contemplated in which the fund may be laddered so that not all of the contracts rollover in September.

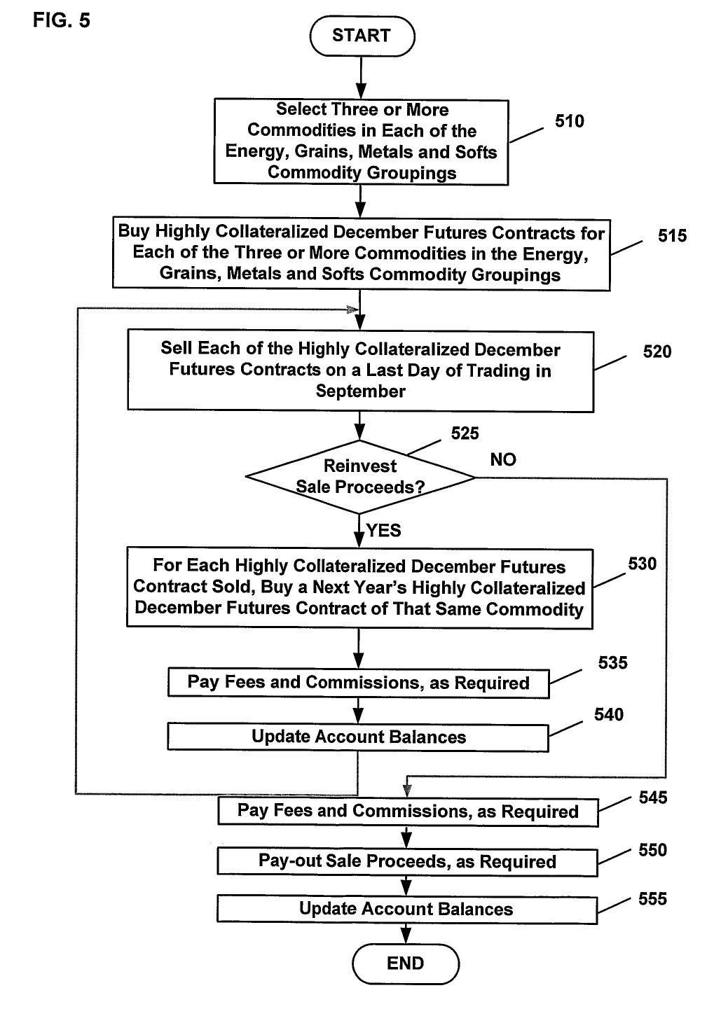

FIG. 5 illustrates a flow diagram for a system and method of providing commodity futures contract trading, in accordance with yet another embodiment of the present invention. In FIG. 5, the method may include selecting (510) three or more commodities in each of energy, grains, metals and softs commodity groupings, and buying (515) highly collateralized December futures contracts for each of the three or more commodities in each of the energy, grains, metals and softs commodity groupings. For example, in September 2005, the method would buy December 2006 futures contracts. The method may also include selling (520) each of the highly collateralized December futures contract on a last day of trading in a September that is three-months earlier than an expiration date of that December futures contract. For example, in September 2006, the method would sell December 2006 futures contracts. The method may also include determining (525) whether to reinvest any proceeds from selling (520) the December futures contracts. If it is determined (525) that the proceeds are to be reinvested, for each highly collateralized December futures contract sold, buying (530) a next year's highly collateralized December futures contract of, generally, that same commodity. For example, in September 2006, the method would buy December 2007 futures contracts. The method may also include paying (535) fees and commissions, as required, and updating (540) account balances by, for example, adding proceeds to and subtracting fees and commissions from the account balances. The method may then loop back to and continue from selling (520) each of the next year's highly collateralized December futures contract on a last day of trading in a September that is three-months earlier than an expiration date of that December futures contract. If it is determined (525) that the proceeds are not to be reinvested, for each highly collateralized December futures contract sold, the method may include paying (545) fees and commissions, as required, paying-out (550) proceeds from the sale of each highly collateralized December futures contract sold, and updating (555) account balances. Embodiments are also contemplated in which the fund may be laddered so that not all of the contracts rollover in September.

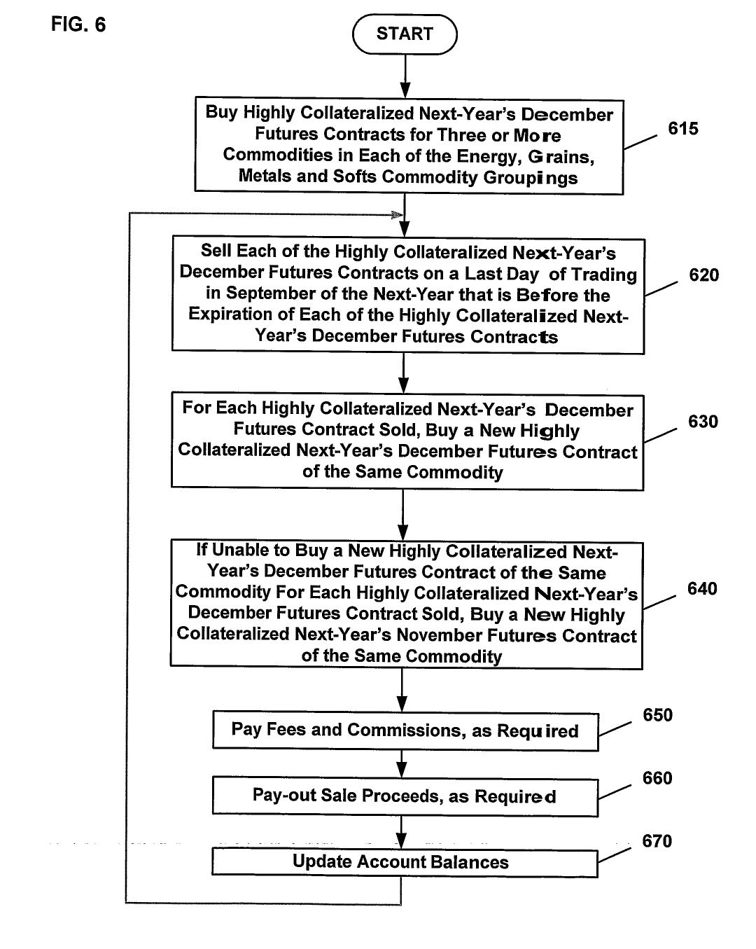

FIG. 6 illustrates a flow diagram for a system and method of providing commodity futures contract trading, in accordance with yet another embodiment of the present invention. In FIG. 6, the method may include buying (615) highly collateralized December futures contracts for each of the three or more commodities in each of energy, grains, metals and softs commodity groupings. For example, in September 2005, the method would buy December 2006 futures contracts. The method may also include selling (620) each of the highly collateralized December futures contract on a last day of trading in a September that is three-months earlier than an expiration date of that December futures contract. For example, in September 2006, the method would sell December 2006 futures contracts. The method may also include, for each highly collateralized December futures contract sold, buying (630) a next year's highly collateralized December futures contract of that same commodity. For example, in September 2006, the method would buy December 2007 futures contracts. If unable to buy a new highly collateralized next-year's December futures contract of the same commodity for each highly collateralized next-year's December futures contract sold, buying (640) a new highly collateralized next-year's November futures contract of the same commodity in that commodity group. The method may also include paying (650) fees and commissions, as required, paying-out (660) proceeds from the sale of each highly collateralized December futures contract sold, and updating (670) account balances. Embodiments are also contemplated in which the fund may be laddered so that not all of the contracts rollover in September.

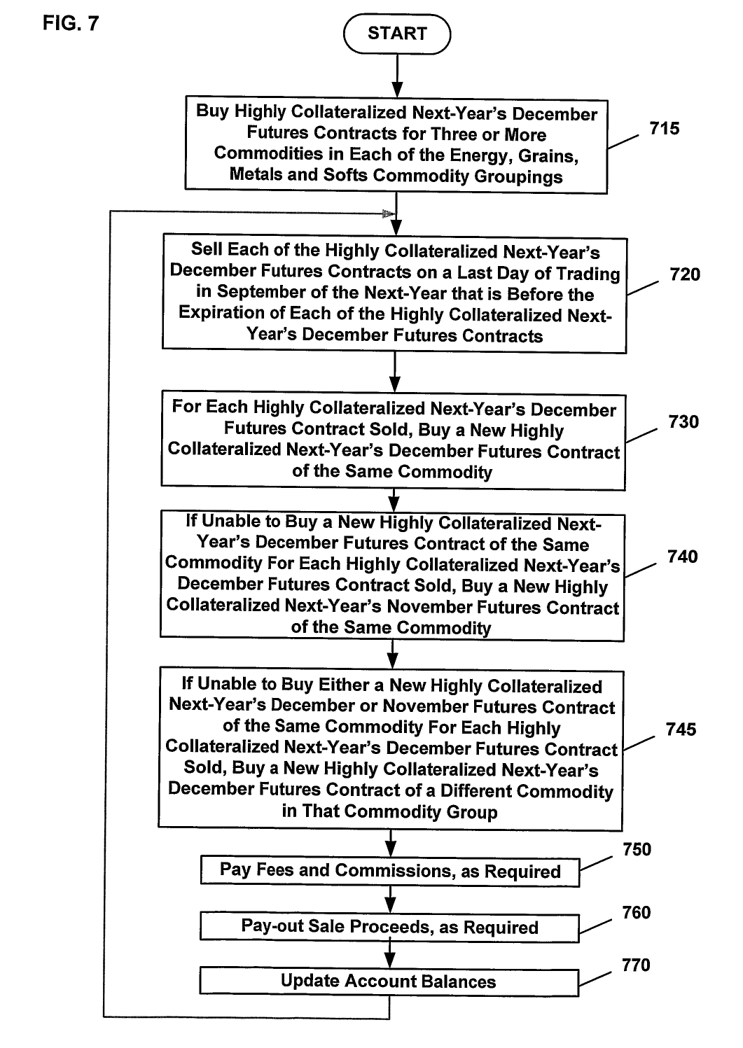

FIG. 7 illustrates a flow diagram for a system and method of providing commodity futures contract trading, in accordance with yet another embodiment of the present invention. In FIG. 7, the method may include buying (715) highly collateralized December futures contracts for each of the three or more commodities in each of energy, grains, metals and softs commodity groupings. For example, in September 2005, the method would buy December 2006 futures contracts. The method may also include selling (720) each of the highly collateralized December futures contract on a last day of trading in a September that is three-months earlier than an expiration date of that December futures contract. For example, in September 2006, the method would sell December 2006 futures contracts. The method may also include, for each highly collateralized December futures contract sold, buying (730) a next year's highly collateralized December futures contract of that same commodity. For example, in September 2006, the method would buy December 2007 futures contracts. If unable to buy a new highly collateralized next-year's December futures contract of the same commodity for each highly collateralized next-year's December futures contract sold, buying (740) a new highly collateralized next-year's November futures contract of the same commodity in that commodity group. If unable to buy a new highly collateralized next-year's December or November futures contract of the same commodity for each highly collateralized next-year's December futures contract sold, buying (740) a new highly collateralized next-year's December futures contract of a different commodity in that commodity group. The method may also include paying (750) fees and commissions, as required, paying-out (760) proceeds from the sale of each highly collateralized December futures contract sold, and updating (770) account balances. Embodiments are also contemplated in which the fund may be laddered so that not all of the contracts rollover in September.

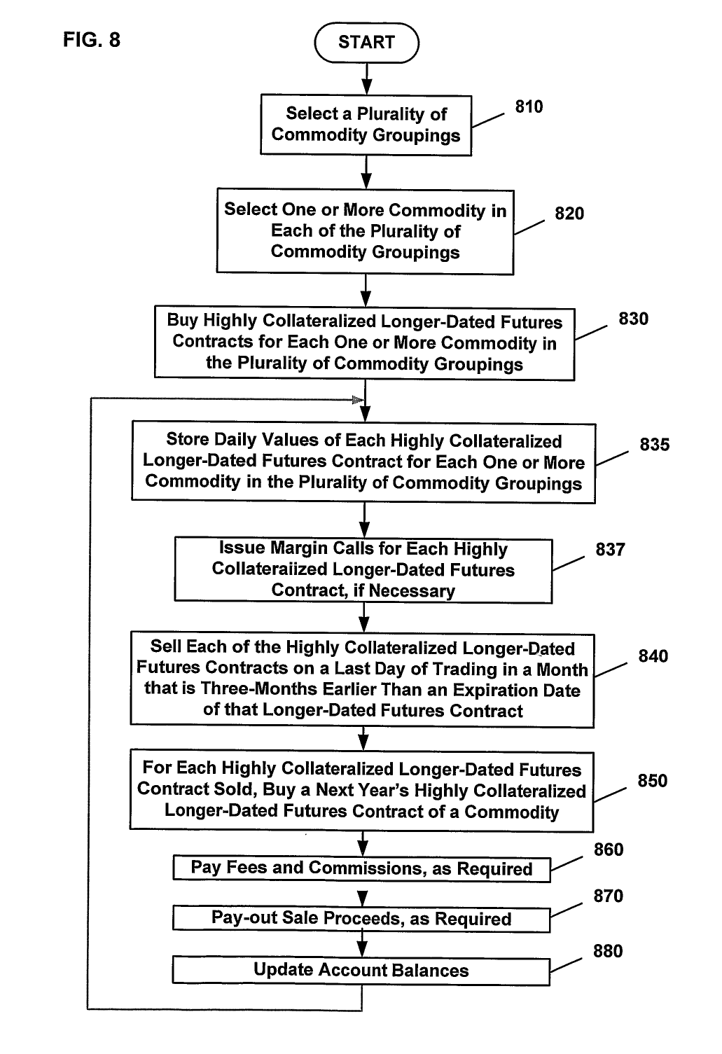

FIG. 8 illustrates a flow diagram for a system and method of providing commodity futures contract trading, in accordance with yet another embodiment of the present invention. In FIG. 8, the method may include selecting (810) a plurality of commodity groupings from which to select specific commodities for an index. For example, the plurality of commodity groupings may include the four, non-financial, traditional basic commodity groups, such as, Energy, Grains, Metals and Softs. The energy group may include oil, gas, etc. commodities; the grain group may include corn, wheat, soybeans, etc. commodities; the metals group may include gold, silver, copper, etc. commodities; and the softs group may include coffee, cocoa, frozen concentrated orange juice, etc. commodities. The previous commodity examples are merely illustrative of an embodiment of the present invention, and in no way should be construed to limit the present invention to that specific embodiment.

In FIG. 8, in accordance with the embodiment of the present invention, the method may include selecting (820) one or more commodities in each of the plurality of commodity groupings. For example, three commodities may be selected (820) in each of the plurality of commodity groupings. The method may include buying (830) highly collateralized longer-dated futures contracts for each of the one or more commodities, for example, three commodities, in the plurality of commodity groupings. In general, this purchase will occur as far in advance of the expiration of the longer-dated futures contracts as possible. For example, the December 2005 futures contracts may be bought (830) in September 2004. The method may include storing (835) daily values of each highly collateralized longer-dated futures contract for each one or more commodities in the plurality of commodity groupings. The method may further include issuing (837) margin calls for each highly collateralized longer-dated futures contract, if necessary. The method may also include selling (840) each of the highly collateralized longer-dated futures contracts on a last day of trading in a month that is three-months earlier than the expiration date of the nearest longer-dated futures contract. For example, a December 2004 futures contract would be sold (840) on the last trading day in September 2004.

In FIG. 8, in accordance with the embodiment of the present invention, the method may include buying (850) a next-year's highly collateralized longer-dated futures contract of a same or different commodity for each highly collateralized longer-dated futures contract sold (840). For example, if a December 2004 Coffee contract was sold (840), a December 2005 Coffee contract may be bought (850). Alternatively, if the December 2005 Coffee contract is not available, a November 2005 Coffee contract may be bought (850). Conversely, if no sufficiently longer-dated 2005 Coffee contracts are available, a longer-dated futures contract for another commodity in the same commodity grouping as Coffee may be bought (850). The method may further include paying (860) fees and commissions associated with the management of the index as well as those associated with the buying and selling of the futures contracts in the index. The method may still further include updating (870) account balances to reflect the net effect of the buying (830, 850) and selling (840) of the futures contracts and the fee and commission charges. The method may pay out proceeds realized from selling (840), if a decision was taken (not shown) not to buy (850) next year's highly collateralized longer-dated futures contracts to replace the one(s) just sold (840) and cash-out some or all of the balance in the investment account.

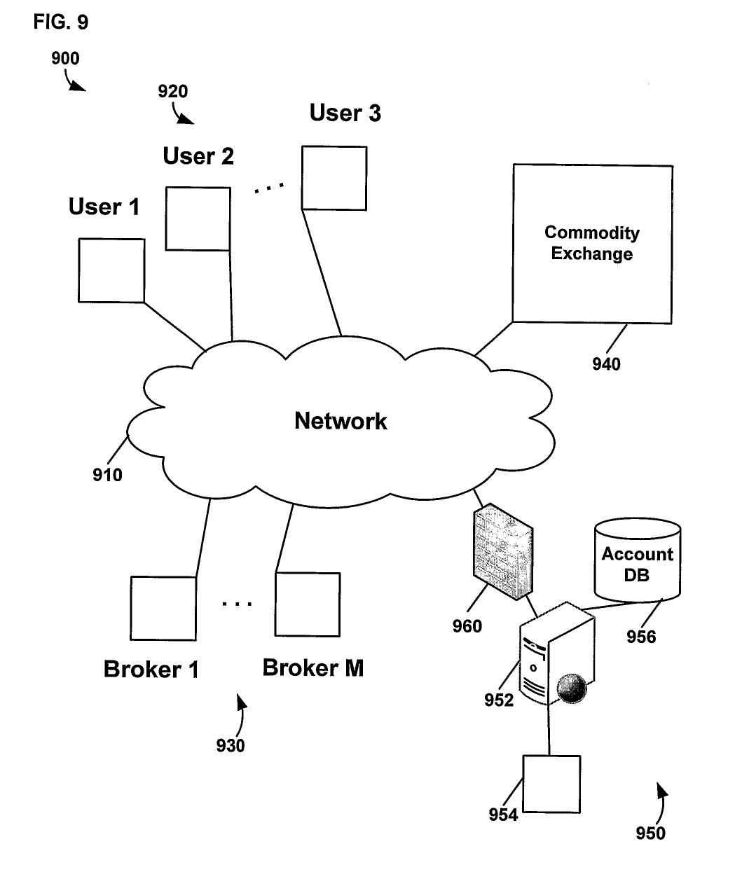

FIG. 9 is a functional block diagram of a system for investing in commodity futures contracts in accordance with an embodiment of the present invention. In FIG. 9, a system 900 may include a network 910, for example, a local area network (LAN), wide area network (WAN), Internet, etc., to which may be connected one or more users (i.e., investors) 920, one or more commodity brokers 930, a commodity exchange 940, and a commodity futures contracts investing system 950. Commodity futures contracts investing system 950 may include a computer/server system 952, which may be a secure system, a management station 954 and an account data base system 956. Commodity futures contracts investing system 950 may be connected to network 910 via a firewall 960. A user 920 may access a web page located at commodity futures contracts investing system 950 and submit an application to become an investor in a commodity futures contract offering on commodity futures contracts investing system 950. Commodity futures contracts investing system 950 may process and analyze the application and determine whether user 920 can be accepted as an investor. If accepted, user 920 may transfer an initial minimum investment to the commodity futures contracts investing system 950, either electronically, by check, or any other method. Once the initial minimum investment has cleared, commodity futures contracts investing system 950 may establish an account in account database 956 and may send a request to one of brokers 930 to purchase a specific commodity index fund. Upon receiving the request, broker 930 may execute a buy order with commodity exchange 940 and send a confirmation to commodity futures contracts investing system 950. Commodity futures contracts investing system 950 may update the users account in account database 956 and notify user 920 of the completed transaction.

Each of the above methods may be implemented using a variety of different means, for example, a variety of combinations of manual procedures, electronic and/or computer programs installed on and used with various computer and communication equipment, such as, a regular computer program, a web-based program, commercially available computer systems, personal digital assistants (PDAs), personal/tablet computers, network and telecommunications equipment, etc. For example, in accordance with one embodiment, the system may be implemented as a web-based application using any one or more of a number of programming languages, such as, but not limited to, HTML, XML, Perl, C++, Java/Java Beans, Visual Basic, etc. The system may be accessed by a manager of the index system as well as investors to make determinations on/configure the system to automatically determine for the investor, for example, which index, which commodities groupings to include in the index, which specific commodities to include in each of the commodities groupings, whether to roll-over proceeds from sales of futures contracts, whether to buy the same or different commodities after selling a futures contract, etc. In general, the web-based system may include a secure server on which is implemented one or more programs to provide the needed functionality for the system. Specifically, this functionality may include establishing and maintaining investment accounts providing manager and investor interfaces to access the system executing trades to buy and sell commodities future contracts and rollovers

Therefore, the method of providing commodity futures contract trading shown in FIG. 1 may be implemented in a system, in accordance with an embodiment of the present invention. For example, the system may include means for selecting a plurality of commodity groupings from which to select specific commodities for an index. For example, the plurality of commodity groupings may include four, non-financial, “traditional” basic commodity groups, such as, Energy, Grains, Metals and Softs. The energy group may include oil, gas, etc. commodities; the grain group may include corn, wheat, soybeans, etc. commodities; the metals group may include gold, silver, copper, etc. commodities; and the softs group may include coffee, cocoa, frozen concentrated orange juice, etc. commodities. The previous commodity examples are merely illustrative of an embodiment of the present invention, and in no way should be construed to limit the present invention to that specific embodiment.

In accordance with the embodiment of the present invention, the system may include means for selecting one or more commodities in each of the plurality of commodity groupings. For example, three commodities may be selected in each of the plurality of commodity groupings. The system may include means for buying highly collateralized longer-dated futures contracts for each of the one or more commodities, for example, three commodities, in the plurality of commodity groupings. In general, this purchase will occur as far in advance of the expiration of the longer-dated futures contracts as possible. For example, the December 2005 futures contracts may be bought in September 2004. The system may also include means for include selling each of the highly collateralized longer-dated futures contracts on a last day of trading in a month that is three-months earlier than the expiration date of the nearest longer-dated futures contract. For example, a December 2004 futures contract would be sold on the last trading day in September 2004.

In FIG. 1, in accordance with the embodiment of the present invention, the system may include means for buying a next-year's highly collateralized longer-dated futures contract of a same or different commodity for each highly collateralized longer-dated futures contract sold. For example, if a December 2004 Coffee contract was sold, a December 2005 Coffee contract may be bought. Alternatively, if the December 2005 Coffee contract is not available, a November 2005 Coffee contract may be bought. Conversely, if no sufficiently longer-dated 2005 Coffee contracts are available, a longer-dated futures contract for another commodity in the same commodity grouping as Coffee may be bought. The method may further include paying (160) fees and commissions associated with the management of the index as well as those associated with the buying and selling of the futures contracts in the index. The system may still further include means for updating account balances to reflect the net effect of the buying and selling of the futures contracts and the fee and commission charges. The system may include means for paying out proceeds realized from selling, if a decision was taken (not shown) not to buy next year's highly collateralized longer-dated futures contracts to replace the one(s) just sold and cash-out some or all of the balance in the investment account.

The foregoing description has been provided for illustrative purposes. Variations and modifications to the embodiments described herein may become apparent to persons of ordinary skill in the art upon studying this disclosure, without departing from the spirit and scope of the present invention.

1. A method for providing a commodities index trading investment system comprising:
selecting a plurality of commodity groupings for an index;
selecting one or more commodities in each of the plurality of commodity groupings;
buying highly collateralized longer-dated futures contracts for each of the one or more commodities:
selling each of the highly collateralized longer-dated futures contracts on a last day of trading in a month that is at least two-months earlier than the expiration date of the nearest longer-dated futures contract;
buying a next-year's highly collateralized longer-dated futures contract of another commodity for each highly collateralized longer-dated futures contract sold;
paying fees and commissions associated with the management of the index as well as those associated with the buying and selling of the futures contracts in the index;
updating account balances to reflect the net effect of the buying and selling of the futures contracts and the fee and commission charges; and
if required, paying-out proceeds from the selling each of the highly collateralized longer-dated futures contracts on the last day of trading in the month that is at least two-months earlier than the expiration date of the nearest longer-dated futures contract.

2. The method of claim 1 wherein the selecting the plurality of commodity groupings for the index comprises:
selecting from four, non-financial, traditional basic commodity groups, wherein commodity price movement in each group has a low correlation with stock and bond prices.

3. The method of claim 2 wherein the selecting from four, non-financial, traditional basic commodity groups comprises:
selecting energy, grains, metals and softs commodity groups.

4. The method of claim 3 wherein the selecting one or more commodities in each of the plurality of commodity groupings comprises:
selecting crude oil, heating oil and natural gas as the energy commodities;
selecting corn, wheat, and soybeans as the metals commodities selecting gold, silver, copper as the metal commodities; and
selecting coffee, cocoa, and frozen concentrated orange juice as the softs commodities.

5. The method of claim 1 wherein the selecting one or more commodities in each of the plurality of commodity groupings comprises:
selecting three commodities in each of the plurality of commodity groupings.

6. The method of claim 1 wherein the buying highly collateralized longer-dated futures contracts for each of the one or more commodities occurs at least fourteen months in advance of the expiration of the longer-dated futures contracts.

7. The method of claim 1 wherein the paying fees and commissions associated with the management of the index as well as those associated with the buying and selling of the futures contracts in the index comprises:
paying out proceeds realized from selling, if a decision was taken not to buy next year's highly collateralized longer-dated futures contracts to replace the one(s) just sold and cash-out some or all of the balance in the investment account.

8. The method of claim 1 wherein the updating of account balances to reflect the net effect of the buying and selling of the futures contracts and the fee and commission charges comprises:
subtracting a cost associated with buying each of the futures contracts from an account for which the futures contracts were bought; and
subtracting a cost associated with selling each of the futures contracts from an account for which the futures contracts were bought.

9. The method of claim 1 wherein the buying a next-year's highly collateralized longer-dated futures contract of a same commodity for each highly collateralized longer-dated futures contract occurs at least fourteen months in advance of the expiration of the longer-dated futures contracts.

10. The method of claim 1 wherein the buying a next-year's highly collateralized longer-dated futures contract of a different commodity for each highly collateralized longer-dated futures contract occurs at least fourteen months in advance of the expiration of the longer-dated futures contracts.

11. A system for providing a commodities index trading investment system comprising:
means for selecting a plurality of commodity groupings for an index;
means for selecting one or more commodities in each of the plurality of commodity groupings;
means for buying highly collateralized longer-dated futures contracts for each of the one or more commodities:
means for selling each of the highly collateralized longer-dated futures contracts on a last day of trading in a month that is least two-months earlier than the expiration date of the nearest longer-dated futures contract;
means for buying a next-year's highly collateralized longer-dated futures contract of another commodity for each highly collateralized longer-dated futures contract sold;
means for paying fees and commissions associated with the management of the index as well as those associated with the buying and selling of the futures contracts in the index;
means for updating account balances to reflect the net effect of the buying and selling of the futures contracts and the fee and commission charges; and
means for paying-out proceeds from the selling each of the highly collateralized longer-dated futures contracts on the last day of trading in the month that is at least two-months earlier than the expiration date of the nearest longer-dated futures contract.

12. The system of claim 11 wherein the means for selecting the plurality of commodity groupings for the index comprises:
means for selecting from four, non-financial, traditional basic commodity groups, wherein commodity price movement in each group has a low correlation with stock and bond prices.

13. The system of claim 11 wherein the means for selecting one or more commodities in each of the plurality of commodity groupings comprises:
means for selecting three commodities in each of the plurality of commodity groupings.

14. The system of claim 11 wherein the means for buying highly collateralized longer-dated futures contracts for each of the one or more commodities is used at least fourteen months in advance of the expiration of the longer-dated futures contracts.

15. The system of claim 11 wherein the means for paying fees and commissions associated with the management of the index as well as those associated with the buying and selling of the futures contracts in the index comprises:
means for paying out proceeds realized from selling, if a decision was taken not to buy next year's highly collateralized longer-dated futures contracts to replace the one(s) just sold and cash-out some or all of the balance in the investment account.

16. The system of claim 11 wherein the means for updating of account balances to reflect the net effect of the buying and selling of the futures contracts and the fee and commission charges comprises:
means for subtracting a cost associated with buying each of the futures contracts from an account for which the futures contracts were bought; and
means for subtracting a cost associated with selling each of the futures contracts from an account for which the futures contracts were bought.

17. The system of claim 11 wherein the means for buying a next-year's highly collateralized longer-dated futures contract of a same commodity for each highly collateralized longer-dated futures contract is used at least fourteen months in advance of the expiration of the longer-dated futures contracts.

18. The system of claim 11 wherein the means for buying a next-year's highly collateralized longer-dated futures contract of a different commodity for each highly collateralized longer-dated futures contract is used at least fourteen months in advance of the expiration of the longer-dated futures contracts.

19. A machine-readable medium having stored thereon a plurality of executable instructions for performing a method comprising:
selecting a plurality of commodity groupings for an index;
selecting one or more commodities in each of the plurality of commodity groupings;
buying highly collateralized longer-dated futures contracts for each of the one or more commodities:
selling each of the highly collateralized longer-dated futures contracts on a last day of trading in a month that is three-months earlier than the expiration date of the nearest longer-dated futures contract;
buying a next-year's highly collateralized longer-dated futures contract of another commodity for each highly collateralized longer-dated futures contract sold;
paying fees and commissions associated with the management of the index as well as those associated with the buying and selling of the futures contracts in the index;
updating account balances to reflect the net effect of the buying and selling of the futures contracts and the fee and commission charges; and
if required, paying-out proceeds from the selling each of the highly collateralized longer-dated futures contracts on the last day of trading in the month that is at least two-months earlier than the expiration date of the nearest longer-dated futures contract.

20. The machine-readable medium of claim 19 wherein the selecting the plurality of commodity groupings for the index comprises:
selecting from four, non-financial, traditional basic commodity groups, wherein commodity price movement in each group has a low correlation with stock and bond prices.

21. The machine-readable medium of claim 20 wherein the selecting from four, non-financial, traditional basic commodity groups comprises:
selecting energy, grains, metals and softs commodity groups.

22. The machine-readable medium of claim 21 wherein the selecting one or more commodities in each of the plurality of commodity groupings comprises:
selecting crude oil, heating oil and natural gas as the energy commodities;
selecting corn, wheat, and soybeans as the metals commodities
selecting gold, silver, copper as the metal commodities; and
selecting coffee, cocoa, and frozen concentrated orange juice as the softs commodities.

23. The machine-readable medium of claim 19 wherein the selecting one or more commodities in each of the plurality of commodity groupings comprises:
selecting three commodities in each of the plurality of commodity groupings.

24. The machine-readable medium of claim 19 wherein the buying highly collateralized longer-dated futures contracts for each of the one or more commodities occurs at least fourteen months in advance of the expiration of the longer-dated futures contracts.

25. The machine-readable medium of claim 19 wherein the paying fees and commissions associated with the management of the index as well as those associated with the buying and selling of the futures contracts in the index comprises:
paying out proceeds realized from selling, if a decision was taken not to buy next year's highly collateralized longer-dated futures contracts to replace the one(s) just sold and cash-out some or all of the balance in the investment account.

26. The machine-readable medium of claim 19 wherein the updating of account balances to reflect the net effect of the buying and selling of the futures contracts and the fee and commission charges comprises:
subtracting a cost associated with buying each of the futures contracts from an account for which the futures contracts were bought; and
subtracting a cost associated with selling each of the futures contracts from an account for which the futures contracts were bought.

27. The machine-readable medium of claim 19 wherein the buying a next-year's highly collateralized longer-dated futures contract of a same commodity for each highly collateralized longer-dated futures contract occurs at least fourteen months in advance of the expiration of the longer-dated futures contracts.

28. The method of claim 19 wherein the buying a next-year's highly collateralized longer-dated futures contract of a different commodity for each highly collateralized longer-dated futures contract occurs at least fourteen months in advance of the expiration of the longer-dated futures contracts.

29. A method for providing a commodities index trading investment system comprising:
selecting a commodity grouping for an index;
selecting one or more commodities from the commodity grouping;
buying highly collateralized longer-dated futures contracts for each of the one or more commodities;
selling each of the highly collateralized longer-dated futures contracts on a last day of trading in a month that is at least two-months earlier than the expiration date of the nearest longer-dated futures contract;
buying a next-year's highly collateralized longer-dated futures contract of another commodity for each highly collateralized longer-dated futures contract sold;
paying fees and commissions associated with the management of the index as well as those associated with the buying and selling of the futures contracts in the index; and
updating account balances to reflect the net effect of the buying and selling of the futures contracts and the fee and commission charges.
